(19) United States
(12) Patent Application Publication
(10) Pub. No.: US 2009/0240675 A1
(43) Pub. Date: Sep. 24, 2009

(54) QUERY TRANSLATION METHOD AND SEARCH DEVICE

(75) Inventors: Tatsuya ASAI, Kawasaki (JP); Shinichiro TAGO, Kawasaki (JP); Seishi OKAMOTO, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/409,675

(22) Filed: Mar. 24, 2009

(30) Foreign Application Priority Data
Mar. 24, 2008 (JP) 2008-076560

(51) Int. Cl. G06F 17/30

(52) U.S. Cl. 707/4; 707/E17.07

(57) ABSTRACT

When a search device receives a query from a terminal device, the search device specifies portions of OR condition containing OR operators from the query. The search device judges whether reverse axes and OR operators are contained in the specified portions of OR condition. When reverse axes and OR operators are contained, the search device divides the query into subqueries using the OR operators contained in the portions of OR condition as division points.

### CROSS-REFERENCE TO RELATED APPLICATIONS

This application is based upon and claims the benefit of priority of the prior Japanese Patent Application No. 2008-076560, filed on Mar. 24, 2008, the entire contents of which are incorporated herein by reference.

### BACKGROUND

1. Field

The present invention relates to a search device that evaluates a search query containing logical expressions and searches for applicable data from document data having a hierarchical structure, and more particularly to a query translation method and a search device that are capable of reducing computational cost.

2. Description of the Related Art

In recent years, as document data processed by a computer, extensible markup language (XML) data has been used. This XML data includes a hierarchical structure using element identifiers “<” and “/>” that are referred to as tags and is possible to carry more information than plain text, and therefore extensible markup language data has been heavily used by computers.

At the time of data search for XML data, with the use of search expressions such as query (XPath expression), a method for searching for document data, nodes, and the like that are applicable to a query has been used (for example, refer to Japanese Patent Application Laid-open No. 2003-323332).

On the other hand, since the volume of XML data is growing larger, it has been desired that document data and nodes applicable to a query are searched based on stream processing (XML data is sequentially referred to and document data and nodes applicable to the query are searched without going backward) in order to reduce the load applied to the computer. However, when the query contains a reverse axis and the like, there is a problem that searching XML data in stream processing is difficult.

FIG. 32 is a detailed diagram to explain a problem when a query contains a reverse axis. As depicted in FIG. 32, in the stream-oriented processing, data having already been read cannot be read again; however, when the query contains a reverse axis, it is necessary to access past data positions (D1 to Dn−1 in FIG. 32) before the current data position (Dn in FIG. 32), which is impossible to perform the stream-oriented processing in which data having been read once is discarded to save the memory (when the query contains a reverse axis, it is necessary to save data read in the past in the memory).

Accordingly, if a query containing reverse axes is translated into a query containing only forward axes (a query for which it is not necessary to access data having been read once at the time of search, in other words, a query in which a reversion to the upper hierarchical nodes is not generated), the computational cost can be reduced.

Hence, conventionally, various technologies that can translate a reverse axis to a forward axis in a query have been devised. For example, in D.01teanu, Forward node-selecting queries over trees, ACM Transactions on Database System (TODS), Volume 32 Issue 1, ACM, March 2007 ISSN: 0362-5915, all OR conditions in a search expression are decomposed into subqueries, followed by translating reverse axes in the subqueries into forward axes.

However, with the use of the conventional technology (for example, D.01teanu, Forward node-selecting queries over trees, ACM Transactions on Database System (TODS), Volume 32 Issue 1, ACM, March 2007 ISSN: 0362-5915), OR conditions not necessary to be decomposed are decomposed, and therefore unnecessary subqueries are created, which leads to a problem that reduction in computational cost is badly affected.

### SUMMARY

It is an object of the present invention to at least partially solve the problems in the conventional technology.

According to an aspect of an embodiment, a query translation method for a search device that evaluates a search query containing logical expressions and searches for applicable data from document data having a hierarchical structure, includes judging whether a reverse axis is contained in the search query; specifying a portion of OR condition containing an OR operator in the search query when the search query contains the reverse axis; judging the OR operator in the specified portion of OR condition that defines a division point for dividing the search query into subqueries; dividing the search query into the subqueries based on the OR operator defining the division point; and translating the reverse axis contained in the subqueries into a forward axis.

According to another aspect of an embodiment, a search device that evaluates a search query containing logical expressions and searches for applicable data from document data having a hierarchical structure, includes a reverse axis judging unit that judges whether a reverse axis is contained in the search query; a division judging unit that specifies a portion of OR condition containing an OR operator in the search query when the search query contains the reverse axis, and judges the OR operator in the specified portion of OR condition that defines a division point for dividing the search query into subqueries; and a translating unit that divides the search query into the subqueries based on the OR operator defining the division point, and translates the reverse axis contained in the subqueries into a forward axis.

According to still another aspect of an embodiment, a computer-readable recording medium that stores therein a computer program to cause a computer to perform the method according to the present invention.

Additional objects and advantages of the invention (embodiment) will be set forth in part in the description which follows, and in part will be obvious from the description, or may be learned by practice of the invention. The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

FIG. 1 is a diagram representing an example of a data structure of XML data and a tree representation of the XML data;

FIG. 2 is a detailed diagram to explain a specific example of a query;

FIG. 3 is a detailed diagram to explain a specific example of another query;

FIG. 4 is a detailed diagram to explain a specific example of still another query;

FIG. 5 is a detailed diagram to explain a specific example of still another query;

FIG. 6 is a diagram representing a configuration of a search system according to a first embodiment;

FIG. 7 is a diagram representing an example of a search result output to an output device of a terminal device;

FIG. 8 is a functional block diagram representing a configuration of the search device according to the first embodiment;

FIG. 9 is a diagram representing an example of each data structure of a step node and a logic symbol node;

FIG. 10 is a diagram representing an example of a data structure of query tree data;

FIG. 11 is a simplified diagram of the query tree data;

FIG. 12 a table representing an example of a data structure of a division management table;

FIG. 13 is a table representing an example of a data structure of a stack;

FIG. 14 is a detailed diagram to explain processing performed by a division point judging unit;

FIG. 15 is a detailed diagram to explain another processing performed by the division point judging unit;

FIG. 16 is a detailed diagram to explain still another processing performed by the division point judging unit;

FIG. 17 is a detailed diagram to explain still another processing performed by the division point judging unit;

FIG. 18 is a detailed diagram to explain normalization;

FIG. 19 is a detailed diagram to explain a query tree of a query q2 when parent axis translation rules are applied;

FIG. 20 is a flow chart representing processing procedures of the search device according to the first embodiment;

FIG. 21 is a flow chart representing query tree generation processing;

FIG. 22 is a flow chart representing step portion correspondence processing;

FIG. 23 is a flow chart representing predicate portion correspondence processing;

FIG. 24 is a flow chart representing left tree correspondence processing;

FIG. 25 is a flow chart representing right tree correspondence processing;

FIG. 26 is a flow chart representing processing procedures of query tree division processing;

FIG. 27 is a flow chart representing another processing procedures of the query tree division processing;

FIG. 28 is a flow chart representing processing procedures of Treesep processing;

FIG. 29 is a flow chart representing processing procedures of Predsep processing;

FIG. 30 is a flow chart representing processing procedures of parent axis translation processing;

FIG. 31 is a diagram representing a hardware configuration of a computer that configures the research device according to the first embodiment; and

FIG. 32 is a detailed diagram to explain a problem when a query contains reverse axes.

### DETAILED DESCRIPTION OF THE PREFERRED EMBODIMENTS

Hereinafter, exemplary embodiments of a query translation method and a search device according to the present invention will be explained in details with reference to the accompanying drawings.

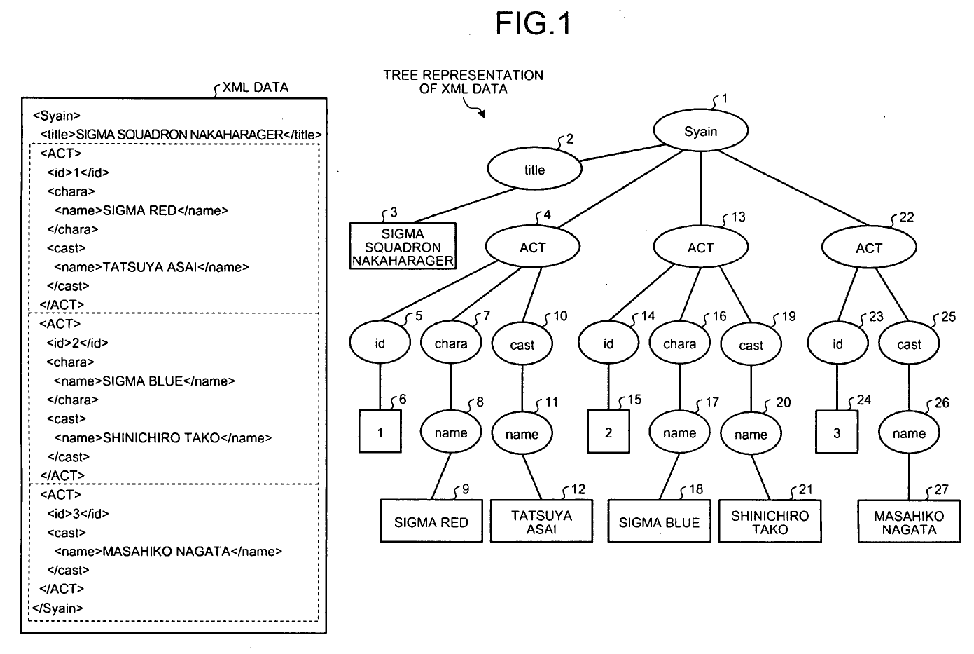

First, extensible markup language (XML) data used in the first embodiment will be explained. FIG. 1 represents an example of a data structure of the XML data and a tree representation of the XML data. As shown on the left side of FIG. 1, the XML data has a hierarchical structure in which elements are delimited by element identifiers “<”, “</”, and the like. The tree representation of the XML data can be represented as shown on the right side of FIG. 1.

In the tree structure of this XML data, the XML data has element nodes, that is, node identifications (IDs) 1, 2, 4, 5, 7, 8, 10, 11, 13, 14, 16, 17, 19, 20, 22, 23, 25, and 26 and text nodes, that is, node IDs 3, 6, 9, 12, 15, 18, 21, 24, and 27. Each element node and each text node are connected to one another. For example, an element node “Syain” of node ID “1” is connected to an element node “title” of node ID “2”, an element node “ACT” of node ID “4”, an element node “ACT” of node ID “13”, and an element node “ACT” of node ID “22”.

Further, a concept of parent (parent axis), child (child axis), preceding-sibling (preceding-sibling axis), following-sibling (following-sibling axis), and the like presents in a query (XPath query), and a concept of parent (parent node), child (child node), preceding-sibling (preceding-sibling node), following-sibling (following-sibling node), and the like presents in XML data. In the explanation using FIG. 1, for example, the relation among Syain of node ID “1”, title of node ID “2”, ACT of node ID “4”, ACT of node ID “13”, and ACT of node ID “22” is defined as parent and children.

Furthermore, the relation among title of node ID “2”, ACT of node ID “4”, ACT of node ID “13”, and ACT of node ID “22” is defined as siblings, and title of node ID “2” is a preceding-sibling of ACT of node ID “14”, ACT of node ID “4” is a preceding-sibling of ACT of node ID “13”, and ACT of node ID “13” is a preceding-sibling of ACT of node ID “22”.

By specifying a query (XPath query), obtaining data at matching positions of the query from the XML data becomes possible. Note that a sub-set of a query according to World Wide Web Consortium (W3C) is, for example, defined as follows.
Query::=Path(“|”Path) (representing OR between queries)
Path::=“/”RPath
RPath::=Step(“/“Step”)*
Step::=Axis“::”Nodetest Pred*
Axis::=ForwardAxis|ReverseAxis
ForwardAxis::=“child”
ReverseAxis::=“parent”
NodeTest::=Tagname|“*”|“text( )”|“node( )”
Pred::=“[Expr”]”
Expr::=RPath|Expr“and”Expr|Expr“or”Expr|“not”Expr

In the above sub-set, when there is no axis name, it is assumed that a child axis (child) is omitted. In addition, “../” in the query described later is an abbreviation of parent axis (parent). Further, when an AND operator and an OR operator present, AND operator takes precedence. Note that syntax in which precedence of operators is determined by ( ) is also permissible.

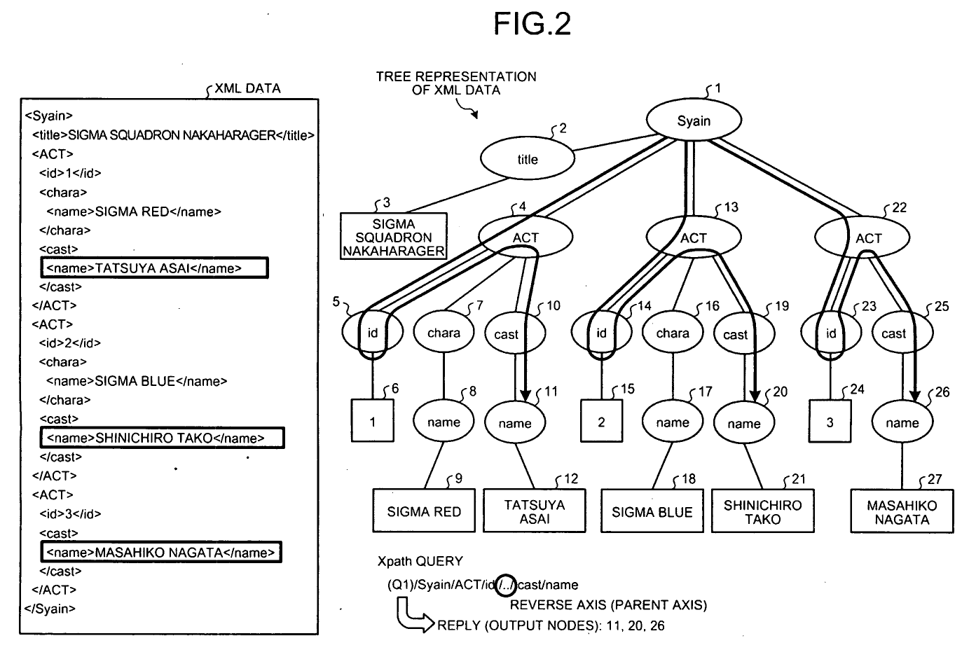

Next, a query for which data is searched from XML data will be specifically explained. FIGS. 2 to 5 are detailed diagrams to explain specific examples of queries. First, the query “Q1=/Syain/ACT/id/../cast/name” depicted in FIG. 2 is explained. For this query, after proceeding from Syain to each ACT and id in turn, the procedure goes back to each “ACT” once that is a parent node of id, and then proceeds from the each ACT to respective casts and names to specify reference positions.

Accordingly, nodes referred to by this query “Q1=/Syain/ACT/id/../cast/name” are “name” of node ID “11”, “name” of node ID “20”, and “name” of node ID “26”, and the information enclosed by the rectangle in the XML data depicted in FIG. 2 is output as a search result.

However, in the query “Q1=/Syain/ACT/id/../cast/name”, a reverse axis (hereinafter, referred to as parent axis) “../” presents, and therefore, after proceeding to each of the element nodes “id”, it is necessary to go back to each “ACT” that is a parent node of “id”. This does not allow searching for nodes applicable to the query based on the stream processing (in the premise that the query contains a reverse axis, it is necessary to save data corresponding to the parent nodes<or data that can be the respective parent nodes>, and a technique in which data having been read once are sequentially discarded similarly to the stream processing cannot be employed).

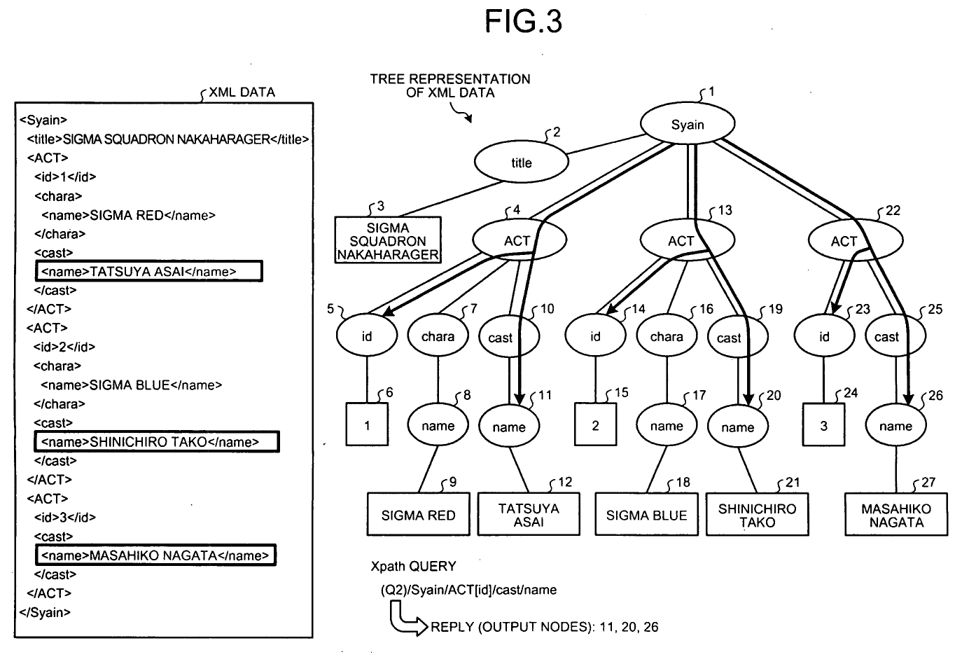

Next, the query “Q2=/Syain/ACT[id]/cast/name” depicted in FIG. 3 will be explained. For this query, after proceeding from Syain, ACTs having “id” in their followings are specified, the procedure proceeds from the specified ACTs to casts and names, and reference positions are specified.

Hence, nodes referred to by the query “Q2=/Syain/ACT[id]/cast/name” are “name” of node ID “11”, “name” of node ID “20”, and “name” of node ID “26” at the same reference positions as those of the query depicted in FIG. 1 (the query Q1 and the query Q2 are queries having the same value), and the information enclosed by the rectangle in the XML data depicted in FIG. 3 is output as a search result.

Here, since any reverse axis (parent axis) does not present in the query “Q2=/Syain/ACT[id]/cast/name”, it is not necessary to reaccess data having been read, and nodes applicable to the query can be searched based on the stream processing. For example, in the example depicted in FIG. 3, at the time when “ACTs” having “id” in their predicates are specified, data before ACTs becomes not necessary, and therefore, similarly to the stream processing, the technique in which data having been read once are sequentially discarded can be employed.

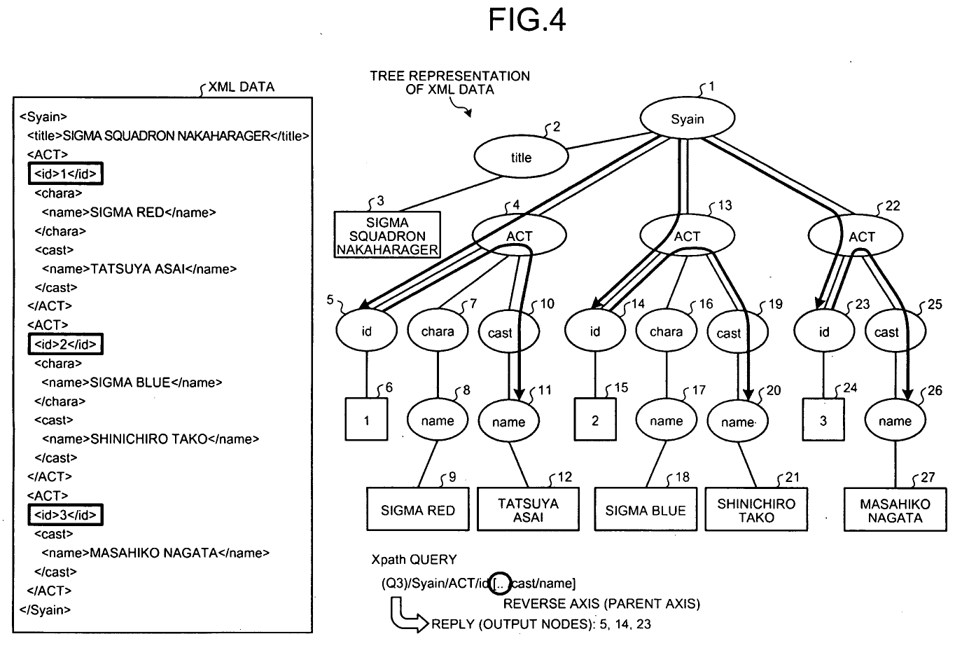

Next, the query “Q3=/Syain/ACT/id[../cast/name]” depicted in FIG. 4 will be explained. For this query, after proceeding from Syain to each ACT and id, the procedure returns to the each “ACT” once that is a parent node of id to confirm whether constraints on id are fulfilled. When cast and name present in the followings of each ACT, the applicable ids are specified for the first time as reference positions.

Therefore, nodes referred to by the query “Q3=/Syain/ACT/id[../cast/name]” are “id” of node ID “5”, “id” of node ID “14”, and “id” of node ID “23”, and the information enclosed by the rectangle in the XML data depicted in FIG. 4 is output as a search result.

However, similarly to the query depicted in FIG. 2, a reverse axis (parent axis) “../” presents in the query depicted in FIG. 4; therefore, after proceeding to the element nodes “id”, it is necessary to go back to “ACTs” that are parent nodes of respective “ids”. This does not allow searching for nodes applicable to the query based on the stream processing.

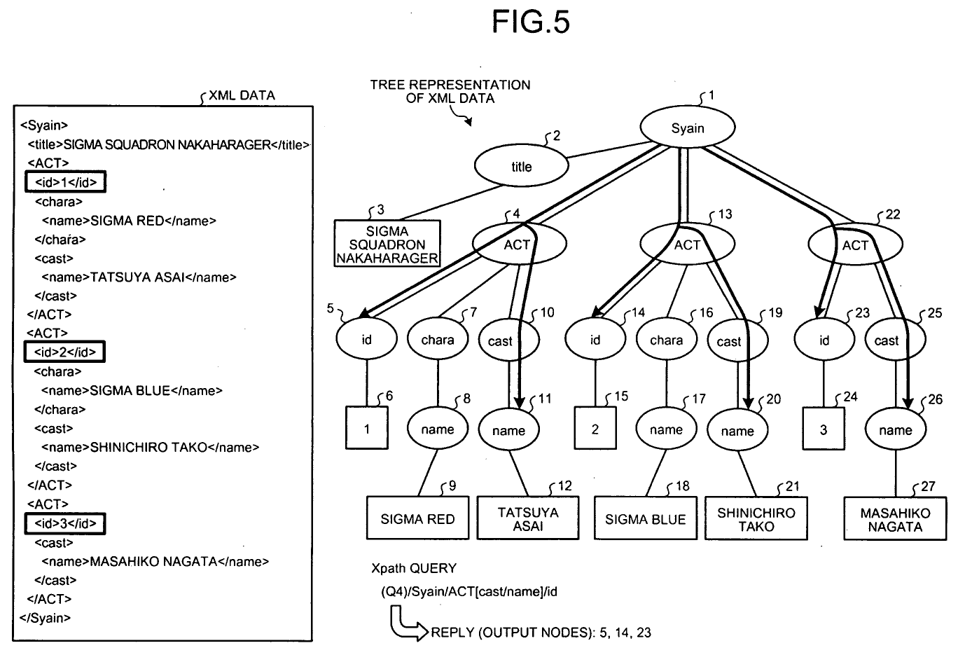

Next, the query “Q4=/Syain/ACT[cast/name]/id” depicted in FIG. 5 will be explained. For this query, after proceeding to Syain, ACTs having “cast/name” in their followings are specified (ACTs fulfilling the constraints are specified). By proceeding from the specified ACTs to ids, reference positions are specified.

Accordingly, nodes referred to by the query “Q4=/Syain/ACT[cast/name]/id” are “id” of node ID “5”, “id” of node ID “14”, and “id” of node “23” at the same reference positions as those of the query depicted in FIG. 4 (the query Q3 and the query Q4 are queries having the same value), and the information enclosed by the rectangle in the XML data depicted in FIG. 5 is output as a search result.

As described above, when data is searched from XML data based on the stream processing and when a query contains a reverse axis, it is necessary for the query to be translated so as not to contain the reverse axis in the query (for example, translating the query Q1 (Q3) into the query Q2 (Q4) is necessary).

Conventionally, when a query containing a reverse axis is translated into a query not containing the reverse axis, parent axis translation rules are applied. In the parent axis translation rules, for example,
(Rule 1) π/a/../≡π[a]
(Rule 2) a[../π]≡.[π]/a
present.

For example, by applying the parent axis translation rule (rule 1) to the query “Q1=/Syain/ACT/id/../cast/name”, the query is translated into “Q1′=/Syain/ACT[id]/cast/name”, which leads to a query not containing a reverse axis; therefore, a reversion is not generated at the time of data search, and searching for nodes applicable to the query based on the stream processing becomes possible.

Further, by applying the parent axis translation rule (rule 2) to the query “Q3=/Syain/ACT/id[../cast/name]”, the query is translated into a query “Q3′=/Syain/ACT[cast/name]/id”, which leads to a query not containing a reverse axis; therefore, a reversion is not generated at the time of data search, and searching nodes applicable to the query based on the stream processing becomes possible.

In respect of the queries Q1 and Q3, they can be translated into queries not containing a reverse axis by the use of the parent axis translation rules as they are. However, for example, when an OR operator and a reverse axis are contained in a query, the parent axis translation rules cannot be used as they are. For example, the parent axis translation rules (the rules 1 and 2) cannot be applied as they are to a query “Q5=/Syain/ACT[(id or ../title)and(chara or cast)]”.

Hence, in D.01teanu, Forward node-selecting queries over trees, ACM Transactions on Database System (TODS), Volume 32 Issue 1, ACM, March 2007 ISSN: 0362-5915, OR operators contained in a query are specified, the query is divided into a plurality of subqueries using the specified OR operators as division points and then, the parent axis translation rules are applied to translate the subqueries containing reverse axes.

For example, when OR operators contained in Q5=/Syain/ACT[(id or ../title)and(chara or cast)] are specified and the query Q5 is divided into subqueries using the specified OR operators as division points, the query is divided into subqueries of q1 to q4, i.e.,
q1=/Syain/ACT[id and chara]
q2=/Syain/ACT[id and cast]
q3=/Syain/ACT[../title and chara]
q4=/Syain/ACT[../title and cast].
Note: Q5=q1|q2|q3|q4

Since each of q3 and q4 among the subqueries q1 to q4 contains a reverse axis, the parent axis translation rules are applied to q3 and q4, and the subqueries q1 to q4 are finally translated into
q1=/Syain/ACT[id and chara]
q2=/Syain/ACT[id and cast]
q3=/Syain[title]/ACT[chara]
q4=/Syain[title]/ACT[cast].

Note that since no reverse axis presents in the subqueries q1 and q2, they remain as they are.

The reference positions of the query Q5 are the reference positions of the subquery q1, the reference positions of the subquery q2, the reference positions of the subquery q3, or the reference positions of the subquery q4. For example, when the XML data depicted in FIG. 1 is searched with the use of the query Q5, “ACT” of node ID “4”, “ACT” of node ID “13”, and “ACT” of node ID “22” are referred to, and therefore the information enclosed by the broken lines in the XML data depicted in FIG. 1 is output as a search result.

However, when the query is divided into subqueries according to the technique disclosed in D.01teanu, Forward node-selecting queries over trees, ACM Transactions on Database System (TODS), Volume 32 Issue 1, ACM, March 2007 ISSN: 0362-5915, part of the query unnecessary to be divided is divided, and this causes to create unnecessary subqueries. This affects reduction in computational cost badly.

Dividing a query is required when the parent axis translation rules cannot be applied to a reverse axis in a portion of OR condition. For example, portions of OR condition in the query “Q5=/Syain/ACT[(id or ../title)and(chara or cast)]” are “id or ../title” and “chara or cast”. The parent axis translation rules cannot be applied to the portion of OR condition “id or ../title”; however, the rules can be applied as they are to the portion of OR condition “chara or cast”. Therefore, the portion is not necessary to be divided into subqueries using the OR operator of “chara or cast” as a division point.

In other words, by judging whether a query is divided based on portions of OR condition, the number of subqueries generated in equivalent translation of a query containing OR operators can be reduced and reduction in computational cost for data search for query becomes possible.

Next, an outline and features of a search device according to the first embodiment will be explained. In the search device according to the first embodiment, a query is not divided into subqueries with the use of all OR operators in the query as division points, which is not like in the conventional technology, OR operators necessary for the query to be divided are specified, and the query is divided into subqueries using only the specified OR operators as division points.

In the search device according to the first embodiment, portions of OR condition containing OR operators are specified in a query. When a reverse axis and an OR operator are contained in the specified portions of OR condition, the query is divided into subqueries using the OR operators contained in the portions of OR condition as division points.

For example, in the query “Q5=/Syain/ACT[(id or ../title)and(chara or cast)]”, portions of OR condition are “id or ../title” and “chara or cast”. In the portions of OR condition, the portion of OR condition containing a reverse axis and an OR operator is “id or ../title”, and therefore the portion is divided into subqueries using the OR operator contained in “id or ../title” as a division point.

More specifically, when the query “Q5=/Syain/ACT[(id or ../title)and(chara or cast)]” is divided into subqueries by the technique of the first embodiment, the subqueries are as follows.
q1=/Syain/ACT[id and (chara or cast)]
q2=/Syain/ACT[../title and (chara or cast)]
Note: Q5=q1|q2

By applying the parent axis translation rules to q2 containing a reverse axis of the subqueries q1 and q2, the subqueries q1 and q2 are finally translated into
q1=/Syain/ACT[id and (chara or cast)]
q2=/Syain[title]ACT[chara or cast].

Note that since the subquery q1 does not have any reverse axis, it remains as it is.

The reference positions for the query Q5 are reference positions of the subquery q1 or reference positions of the subquery q2. For example, when the XML data depicted in FIG. 1 is searched for the query Q5, “ACT” of node ID “4”, “ACT” of node ID “13”, and “ACT” of node ID “22” are referred to, and therefore the information enclosed by the broken lines in the XML data depicted in FIG. 1 is output as a search result.

Here, when the number of subqueries divided by the conventional technology and the number of subqueries divided by the technique of the first embodiment are compared with each other, the number of subqueries divided by the technique of the first embodiment is smaller; therefore, the search device can reduce the number of search for query and the computational cost. For example, in respect of the query Q5, four subqueries are created by the conventional technique, whereas only two subqueries are created by the technique of the first embodiment. Accordingly, in regard to the query Q5, the number of search can be reduced to two.

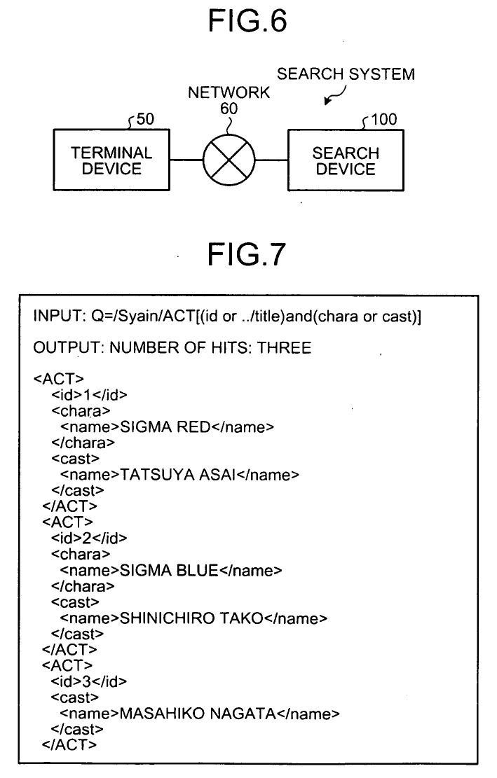

Next, a search system provided with the search device of the first embodiment will be explained (an example). FIG. 6 is a diagram representing a configuration of the search system according to the first embodiment. As depicted in FIG. 6, the search system is provided with a terminal device 50 and a search device 100, and the terminal device 50 and the search device 100 are connected to each other by a network 60.

The terminal device 50 is a device that transmits information on a received query to the search device 100 when the terminal device 50 receives the query from a user via an input device (not shown) and outputs a search result output from the search device 100 to an output device (not shown). FIG. 7 is a diagram representing an example of a search result output to the output device of the terminal device 50.

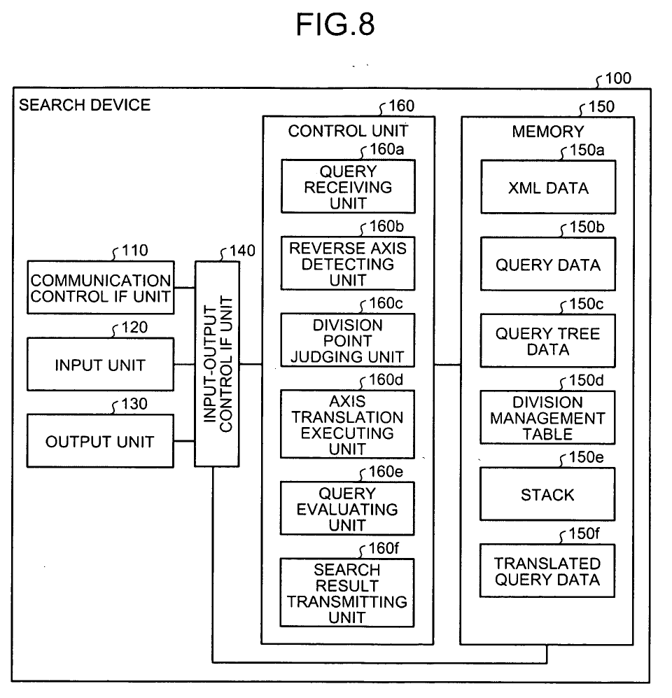

The search device 100 is a device that searches data corresponding to the query from XML data when the search device 100 receives the information on the query from the terminal device 50 and transmits a search result to the terminal device 50. FIG. 8 is a functional block diagram representing a configuration of the search device 100 according to the first embodiment.

As depicted in FIG. 8, the search device 100 is configured with a communication control IF (or interface) unit 110, an input unit 120, an output unit 130, an input-output control IF unit 140, a memory 150, and a control unit 160.

The communication control IF unit 110 is a unit that controls communication mainly with the terminal device 50. The input unit 120 is an input unit that inputs various information and is configured with a keyboard, a mouse, a microphone, and the like.

The output unit 130 is an output unit that outputs various information and is configured with a monitor (or a display or a touch panel), and a speaker. The input-output control IF unit 140 is a unit that controls input and output of data that are performed by the communication control IF unit 110, the input unit 120, the output unit 130, the memory 150, and the control unit 160.

The memory 150 is a storage unit that stores data and programs necessary for various processing carried out by the control unit 160, and particularly as data closely related to the present invention, XML data 150a, query data 150b, query tree data 150c, a division management table 150d, a stack 150e, and translated query data 150f are stored in the memory 150 as depicted in FIG. 8.

The XML data 150a among the data is document data having a hierarchical structure in which elements are delimited by element identifiers “<”, “</”, and the like (refer to the left side of FIG. 1). The query data 150b is data of a query transmitted from the terminal device 50. For example, the query data 150b is “Q=/Syain/ACT[(id or ../title)and(chara or cast)]”.

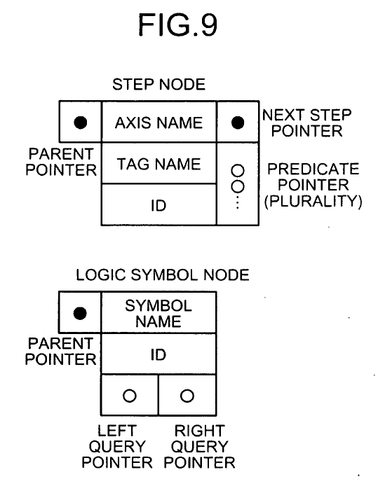

The query tree data 150c is data of a query tree generated based on the query data 150b. This query tree data 150c has step nodes and logic symbol nodes. FIG. 9 is a diagram representing an example of data structures of a step node and a logic symbol node.

As shown on the upper side of FIG. 9, the step node has an ID (node ID), an axis name (Axis), a tag name (Tag), a next step pointer (NextPT; pointing to a step node), predicate pointers (ParPTs; pointing to step nodes or logic symbol nodes), and a parent pointer (ParPT; pointing to a step node or a logic symbol node).

As shown on the lower side of FIG. 9, the logic symbol node has an ID (node ID), a symbol name (Symbl), a left query pointer (LeftPT; pointing to a step node or a logic symbol node), a right query pointer (RightPT; pointing to a step node or a logic symbol node), and a parent pointer (ParPT; pointing to a step node or a logic symbol node).

Note that step in a query is defined as

Step::=Axis“::”Nodetest ([Predicate])*. That is, step is a triple (axis, tag name, and predicate). For example, a query/A[B]C[DorE]F has three steps, that is, A[B], C[D or E], and F.

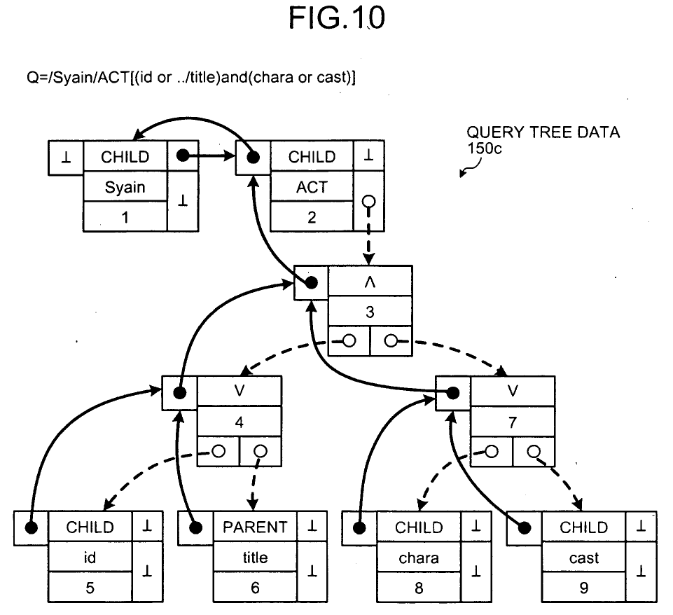

FIG. 10 is a diagram representing an example of a data structure of the query tree data 150c. The query tree data 150c depicted in FIG. 10 represents a query tree of a query “Q=/Syain/ACT[(id or ../title)and(chara or cast)]”.

As depicted in FIG. 10, the query tree data 105c has a step node of node ID “1”, an axis name “child”, and a tag name “Syain”, a step node of node ID “2”, an axis name “child”, and a tag name “ACT”, a logic symbol node of node ID “3” and a symbol name “ [symbol] ; AND”, a logic symbol node of node ID “4” and a symbol name “ [symbol] ; AND”, a step node of node ID “5”, an axis name “child”, and a tag name “id”, a step node of node ID “6”, an axis name “parent”, and a tag name “title”, a logic symbol node of node ID “7” and a symbol name “ [symbol] ; AND”, a step node of node ID “8”, an axis name “child”, and a tag name “chara”, and a step node of node ID “9”, an axis name “child”, and a tag name “cast”.

A next step pointer of the step node of node ID “1” points to the step node of node ID “2”. Further, a predicate pointer of the step node of node ID “2” points to the logic symbol node of node ID “3”, and a parent pointer thereof points to the step node of node ID “1”.

A left query pointer of the logic symbol node of node ID “3” points to the logic symbol node of node ID “4”, a right query pointer thereof points to the logic symbol node of node ID “7”, and a parent pointer thereof points to the step node of node ID “2”.

A left query pointer of the logic symbol node of node ID “4” points to the step node of node ID “5”, a right query pointer thereof points to the step node of node ID “6”, and a parent pointer thereof points to the logic symbol node of node ID “13”.

A parent pointer of the step node of node ID “5” points to the logic symbol node of node ID “4”, and a parent pointer of the step node of node ID “6” points to the logic symbol node of node ID “14”.

A left query pointer of the logic symbol node of node ID “7” points to the step node of node ID “8”, a right query pointer thereof points to the step node of node ID “9”, and a parent pointer thereof points to the logic symbol node of node ID “3”.

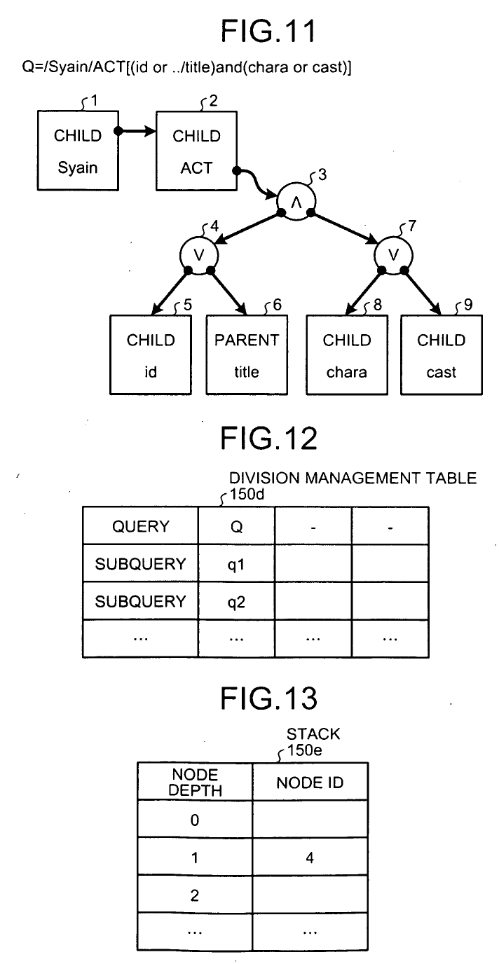

A parent pointer of the step node of node ID “8” points to the logic symbol node of node ID “7”, and a parent pointer of the step node of node ID “9” points to the logic symbol node of node ID “7”. Note that the symbols “” in FIG. 10 mean null (empty). In the following explanation, the query tree data 150c depicted in FIG. 10 is explained in a simplified diagram as depicted in FIG. 11. FIG. 11 is a simplified diagram of the query tree data 150c.

The division management table 150d is data to manage the relation between a query and its divided subqueries. FIG. 12 is a table representing an example of a data structure of a division management table. As depicted in FIG. 12, the division management table 150d has a query and each subquery. In the example depicted in FIG. 12, it is stored that a query “Q” is divided into subqueries “q1” and “q2”.

The stack 150e is data that manages node IDs of logic symbol nodes to be candidates for division points. FIG. 13 is a table representing an example of a data structure of the stack 150e. As depicted in FIG. 13, this stack 150e is provided with node depth and node ID. Here, node depth represents a depth of a logic symbol node. Note that any definition of depth of logic symbol node may be acceptable, and for example, a depth can be defined as the number of logic symbol nodes contained from a root to an applicable logic symbol node.

For example, when the logic symbol node of node ID “4” is registered in the stack 150e, there is one logic symbol node contained from the root to the applicable logic symbol node, and therefore the depth of the node is “1”.

The translated query data 150f is query data translated so as not to contain a reverse axis. For example, the translated query data 150f corresponding to query data “Q=/Syain/ACT[(id or ../title)and(chara or cast)]” is
“q1=/Syain/ACT[id and (chara or cast)] and “q2=/Syain/ACT[../title and (chara or cast)]”.

The control unit 160 has internal memory to store programs defining various procedures for processing and control data, and is a control unit that performs various processing using the programs and the control data. As particular units closely related to the present invention, as depicted in FIG. 8, the control unit 160 includes a query receiving unit 160a, a reverse axis detecting unit 160b, a division point judging unit 160c, an axis translation executing unit 160d, a query evaluating unit 160e, and a search result transmitting unit 160f.

The query receiving unit 160a is a unit to store information on a received query as the query data 150b in the memory 150 when the query receiving unit 160a receives the information on the query from the terminal device 50.

The reverse axis detecting unit 160b is a unit to judge whether a reverse axis (a parent axis “../”) is contained in the query data 150b. When the reverse axis detecting unit 160b judges that a reverse axis is contained, outputs information that a reverse axis is contained to the division point judging unit 160c. When any reverse axis is not contained, processing in which the query data 150b is divided into subqueries is not performed, the query evaluating unit 160e (described later) evaluates the query data 150b as it is, and applicable data is detected from the XML data 150a.

The division point judging unit 160c is a unit to judge division points of the query data 150b when the reverse axis is contained in the query data 150b and divide the query data 150b based on the division points.

Specifically, the division point judging unit 160c specifies portions of OR condition containing OR operators in the query data 150b. When OR operators and reverse axes are contained in the specified portions of OR condition, the division point judging unit 160c judges the OR operators contained in the applicable portions of OR condition as division points.

For example, in a query “Q5=/Syain/ACT[(id or ../title)and(chara or cast)]”, portions of OR condition are “id or ../title” and “chara or cast”. In the portions of OR condition, the portion of OR condition containing a reverse axis and an OR operator is “id or ../title”, and therefore the division point judging unit 160c judges the OR operator contained in “id or ../title” as a division point.

Hereinafter, specific processing in which the division point judging unit 160c judges a division point will be explained. When a division point is judged, the division point judging unit 160c creates the query tree data 150c from the query data 150b using a well-known technique. Then, part from the root “r” to a step node “a” of the query tree data 150c is defined as a pass “P”. When an axis name of the step node “a” represents a “reverse axis”, the lowest OR node ( [symbol] node) of the logic symbol nodes on the pass “P” is judged as a division point.

The division point judging unit 160c carries out preorder walk (or sequence) in the query tree data 150c and manages the depths of OR nodes appearing on the current pass in the stack 150e. When a reverse axis is found in a step node, the division point judging unit 160c accesses the stack 150e and judges a division point. In the present technique, dividing the query tree data 150c is carried out in sequence from the bottom (from the bottom up). Therefore, the lowest node of the OR nodes containing a reverse axis in portions of OR condition is defined as a division point.

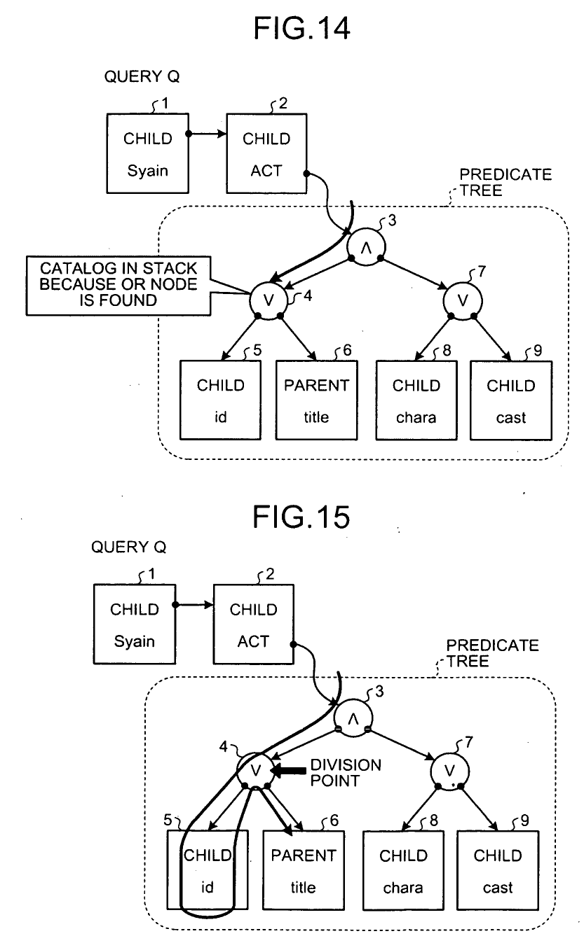

FIGS. 14 to 17 are detailed diagrams to explain processing carried out by the division point judging unit 160c (refer to FIG. 10 for details of node IDs “1” to “9” in FIGS. 14 to 17). First, the division point judging unit 160c carries out depth-first search for the predicate tree. When the division point judging unit 160c detects an OR node ( [symbol] node), correlates the OR node with a node depth and a node ID and registers the node in the stack 150e. In the example depicted in FIG. 14, the logic symbol node of node ID “4” is applicable; therefore, a node depth “1” and node ID “4” are correlated with the logic symbol node and the logic symbol node is registered in the stack 150e.

Sequentially, when a reverse axis is detected at the time of the depth-first search, the division point judging unit 160c judges a node registered at the deepest position as a division point if the stack 150e is not empty. In the example depicted in FIG. 15, a reverse axis is detected in the step node of node ID “6”, and therefore the division point judging unit 160c judges the lowest OR node (in the example depicted in FIG. 15, the logic symbol node of node ID “4”) in the stack 150e as a division point.

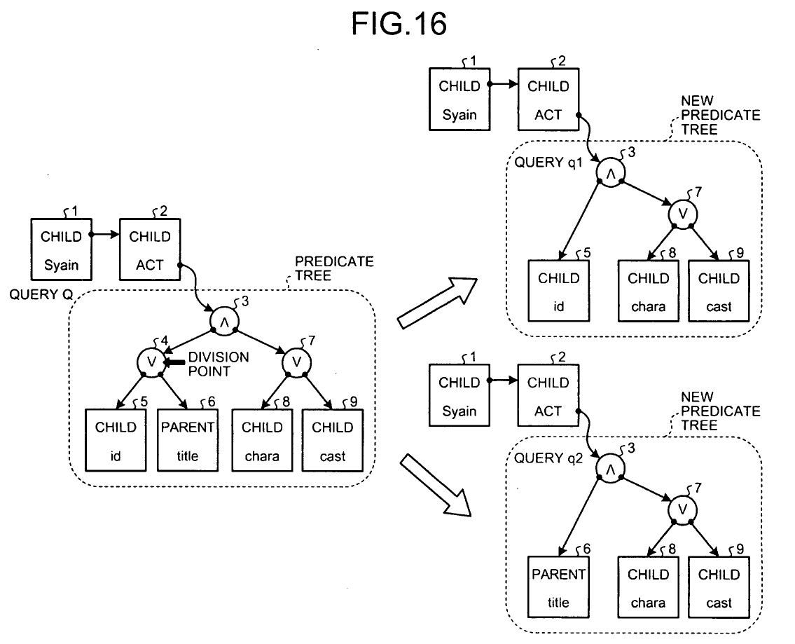

After judging the division point, the division point judging unit 160c divides the query tree data based on the division point. In the example depicted in FIG. 16, the query Q shown on the left side of FIG. 16 is divided into subqueries q1 and q2 using the logic symbol node of node ID “4” as a division point. Note that as to the query tree before the division, the old predicate tree is replaced with new predicate trees (the number of copies of the query tree to be replaced is increased by the number of the devided trees). The division point judging unit 160c correlates the query Q before the division with the subqueries q1 and q2 after the division and registers them in the division management table 150d.

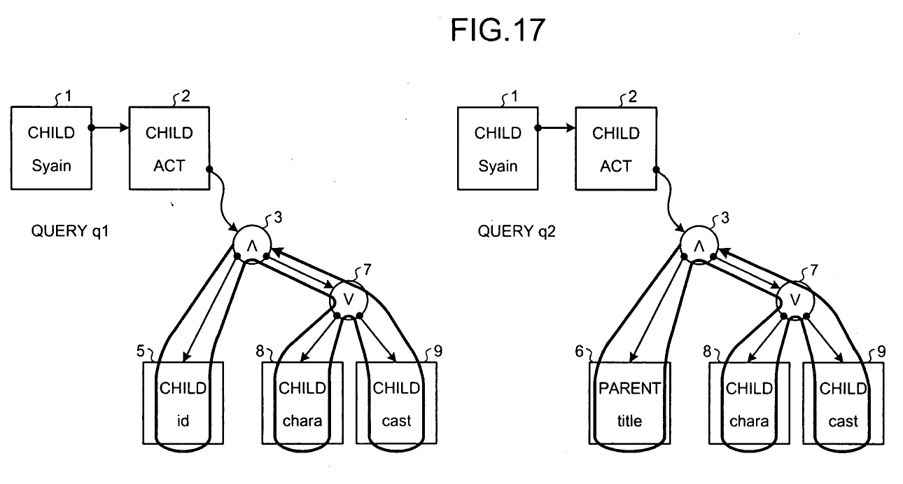

The division point judging unit 160c repeats the processing for the query trees after the division and continues the processing until each query tree cannot be divided. In the example depicted in FIG. 17, any division point presents in neither query tree, and therefore, the dividing of the query tree ends.

The division point judging unit 160c divides the query tree data 150c, followed by normalizing the query trees after the division by applying equivalence rules that is,
π[π1[π2]]≡π[π1/π2]
π[[π1[π2]≡π[π1][π2]

to the each divided query tree.

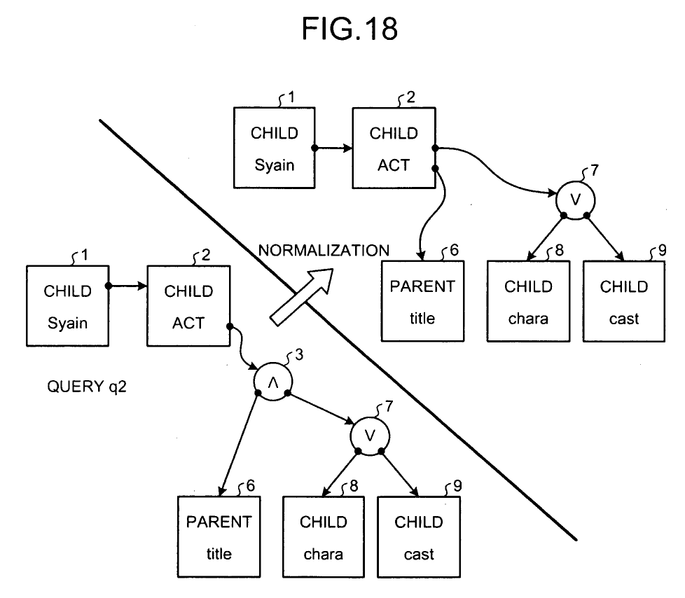

FIG. 18 is a detailed diagram to explain the normalization. Here, shown is an example in which the equivalence rules are applied to the query q2 after the division. When the equivalence rules are applied to the query q2, the step node of node ID “6” and the logic symbol node of node ID “7” are specified by the predicate pointers of the step node of node ID “2”, and the logic symbol node of node ID “3” is deleted.

The division point judging unit 160c outputs the query data after the division to the axis translation executing unit 160d. The query data “Q=/Syain/ACT[(id or ../title)and(chara or cast)]” is divided into subqueries “q1=/Syain/ACT[id and (chara or cast)] and “q2=/Syain/ACT[../title and (chara or cast)]” by the division point judging unit 160c and the data is output to the axis translation executing unit 160d.

The axis translation executing unit 160d is a unit that translates a query into a query not containing a reverse axis by applying the parent axis translation rules. For example, when the subqueries “q1=/Syain/ACT[id and (chara or cast)] and “q2=/Syain/ACT[../title and (chara or cast)]” are obtained from the division point judging unit, the parent axis translation rules are applied to the subquery q2 containing a reverse axis, and q2=/Syain/ACT[../title and (chara or cast)] is translated into q2=/Syain[title]ACT[chara or cast]. The subquery q1 does not contain any reverse axis, and therefore the query is as it is.

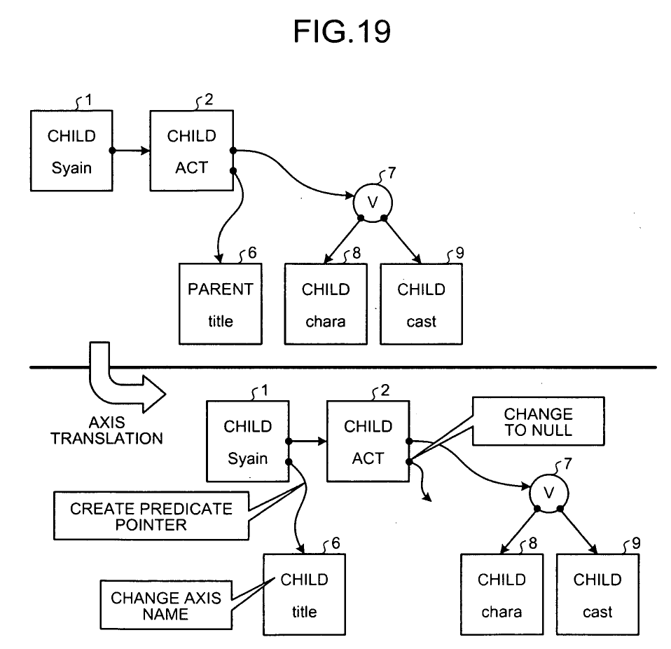

FIG. 19 is a detailed diagram to explain the query tree of the query q2 when the parent axis translation rules are applied. As depicted in FIG. 19, when the parent axis translation rules are applied to the query q2, the step node of node ID “6” is specified by the predicate pointer of the step node of node ID “1”, the axis name of the step node of node ID “6” is translated into “child”. The information on the step node of node ID “6” having been specified by the predicate pointer of node ID “2” is changed to null.

The axis translation executing unit 160d stores the query data after the translation as the translated query data 150f in the memory 150. For example, the translated query data 150f corresponding to the query “Q=/Syain/ACT[(id or ../title)and(chara or cast)]” is
q1=/Syain/ACT[id and (chara or cast)] q2=/Syain/ACT[../title and (chara or cast)].

The query evaluating unit 160e evaluates the translated query data 150f, searches for applicable data from the XML data 150a, and outputs a search result to the search result transmitting unit 160f. For example, when the query evaluating unit 160e evaluates
q1=/Syain/ACT[id and (chara or cast)] q2=/Syain/ACT[../title and (chara or cast)],

applicable nodes are ACT of node ID “4”, ACT of node ID “13”, and ACT of node ID “22”, and therefore the information enclosed by the broken lines in the XML data depicted in FIG. 1 is detected as a search result.

The search result transmitting unit 160f is a unit to output an obtained search result to the terminal device 50 when the search result is obtained from the query evaluating unit 160e.

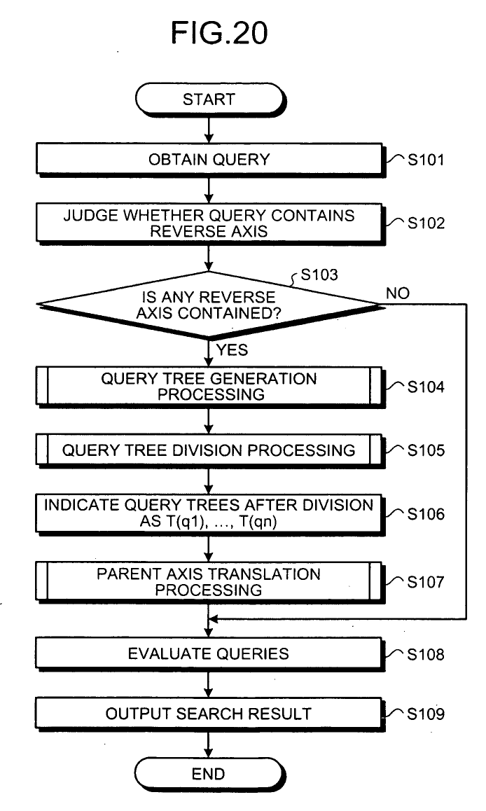

Next, processing procedures performed by the search device 100 according to the first embodiment will be explained. FIG. 20 is a flow chart representing processing procedures carried out by the search device 100 according to the first embodiment. As depicted in FIG. 20, the search device 100 obtains a query (Step S101) and judges whether the query contains a reverse axis (Step S102).

When any reverse axis is not contained in the query (No at Step S103), the procedure proceeds to Step S108. On the other hand, when the query contains a reverse axis (Yes at Step S103), query tree generation processing is performed (Step S104), query tree division processing is performed (Step S105), query trees after the division are indicated as T(q1), . . . , T(qn) (Step S106), and parent axis translation processing is carried out (Step S107).

Subsequently, the search device 100 evaluates the queries (Step S108) and outputs a search result (Step S109).

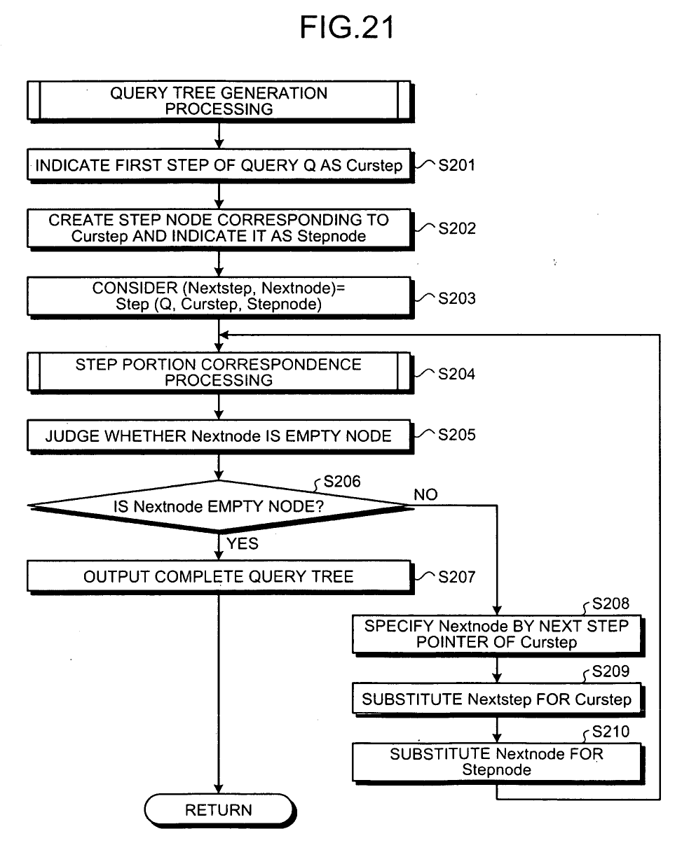

Next, the query tree generation processing shown at step S104 in FIG. 20 will be explained. FIG. 21 is a flow chart representing the query tree generation processing. In the flow chart in FIG. 21, an input is a query Q and an output is a query tree T. Further, Curstep, Stepnode, Nextstep, Nextnode are local variables. Curstep is a current step, Stepnode is a step structure corresponding to Curstep, Nextstep is a next step, and Nextnode is a step node structure corresponding to Nextstep.

As depicted in FIG. 21, the first step of the query Q is indicated as Curstep (Step S201), a step node corresponding to Curstep is created, and the step node is indicated as Stepnode (Step S202).

Then, (Nextstep, Nextnode)=Step (Q, Curstep, Stepnode) is defined (Step S203), and step portion correspondence processing is performed using (Nextstep, Nextnode)=Step (Q, Curstep, Stepnode) as an input (Step S204).

Subsequently, the search device 100 judges whether Nextnode is an empty node (Step S205). When Nextnode is an empty node (Yes at Step S206), the complete query tree is output (Step S207), and the query tree generation processing ends.

On the other hand, when Nextnode is not an empty node (No at Step S206), Nextnode is specified by the next step pointer of Curstep (Step S208), Nextstep is substituted for Curstep (Step S209), Nextnode is substituted for Stepnode (Step S210), and the procedure proceeds to the step S204.

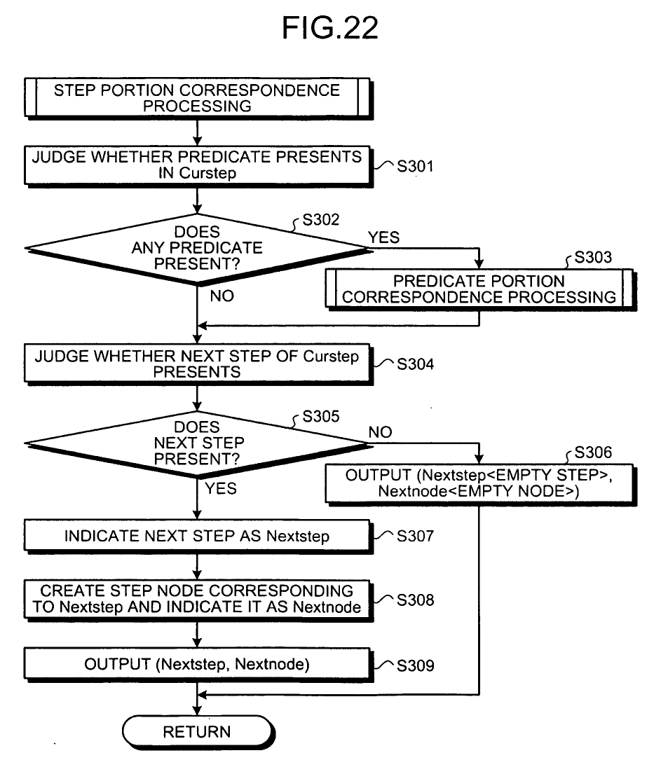

Next, the step portion correspondence processing shown at step S204 in FIG. 21 will be explained. FIG. 22 is a flow chart representing the step portion correspondence processing. In FIG. 22, inputs are Q (query), Curstep (current step), and Stepnode (step node structure corresponding to Curstep), and outputs are Nextstep (next step) and Nextnode (step node structure corresponding to Nextstep).

As depicted in FIG. 22, whether a predicate presents in Curstep is judged (Step S301). When a predicate presents (Yes at Step S302), predicate portion correspondence processing is performed using Pred (Q, Curstep, and Stepnode) as an input (Step S303), and the procedure proceeds to Step S304.

On the other hand, when any predicate does not present in Curstep (No at Step S302), whether a next step of Curstep presents is judged (Step S304). When any next step does not present (No at Step S305), (Nextstep<empty step>, Nextnode<empty node>) is output (Step S306), and the step portion correspondence processing ends.

On the other hand, when a next step of Curstep presents (Yes at Step S305), the next step is indicated as Nextstep (Step S307), a step node corresponding to Nextstep is created, the created step node is indicated as Nextnode (Step S308), (Nextstep, Nextnode) is output (Step S309), and the step portion correspondence processing ends.

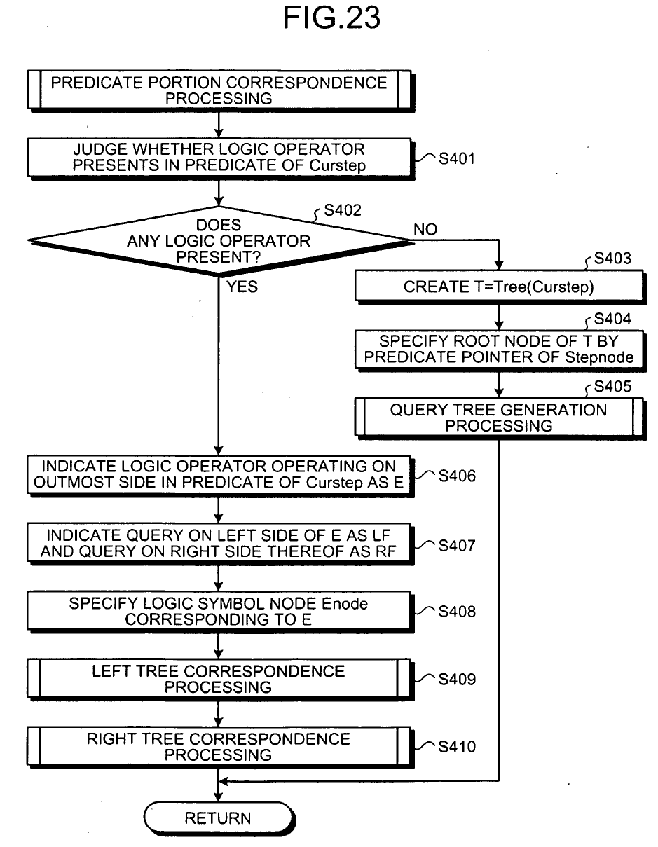

Next, the predicate portion correspondence processing shown at step S303 in FIG. 22 will be explained. FIG. 23 is a flow chart representing the predicate portion correspondence processing. In FIG. 23, inputs are Q (query), Curstep (current step), and Stepnode (step node structure corresponding to Curstep).

As depicted in FIG. 23, whether a logic operator presents in the predicate of Curstep is judged (Step S401). When any logic operator does not present (No at Step S402), T=Tree(Curstep) is created (Step S403), a predicate pointer of Stepnode specifies the root node of T (Step S404), query tree generation processing is performed (Step S405), and the predicate portion correspondence processing ends.

On the other hand, when logic operators present in the predicate of Curstep (Yes at Step S402), a logic operator operating on the outmost side in the predicate of Curstep is indicated as E (Step S406). At step S406, when the predicate is considered as “(id or ../title)and(chara or cast)”, the operators contain one logical AND “and” and two logical ORs “ors”. In this case, the logic operator operating on the outmost side is the logical AND “and”.

Subsequently, the query on the left side of E is indicated as LF and the query on the right side thereof is indicated as RF (Step S407), and logic symbol node Enode corresponding to E is specified (Step S408). Left tree correspondence processing is performed using Lefttree(LF, Enode) as an input (Step S409), right tree correspondence processing is performed using Righttree (RF, Enode) as an input (Step S410), and the predicate portion correspondence processing ends.

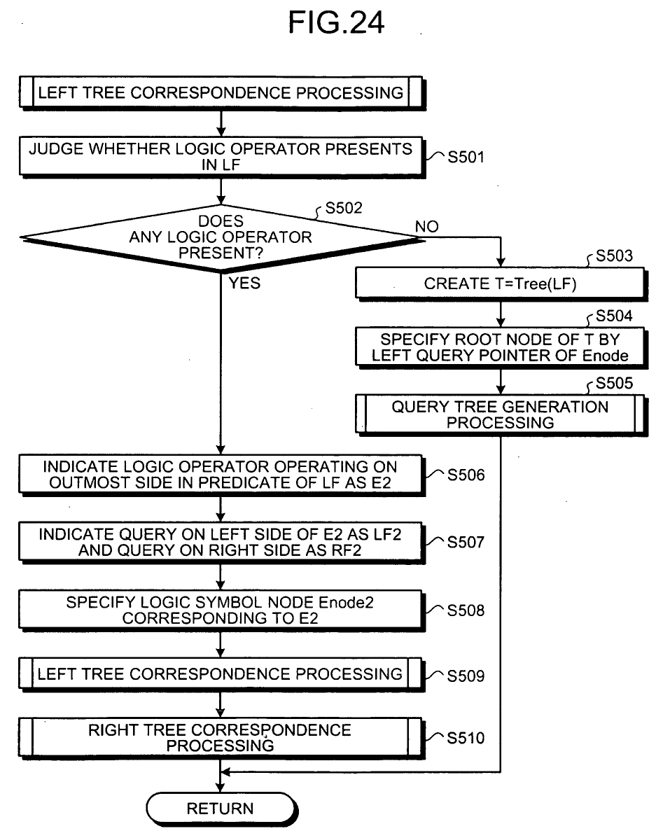

Next, the left tree correspondence processing shown at step S409 in FIG. 23 will be explained. FIG. 24 is a flow chart representing the left tree correspondence processing. In FIG. 24, inputs are LF (query) and Enode (logic symbol node).

As depicted in FIG. 24, whether a logic operator presents in LF is judged (Step S501). When any logic operator does not present (No at Step S502), T=Tree(LF) is created (Step S503), the left query pointer of Enode specifies the root node of T (Step S504), query tree generation processing is performed (Step S505), and the left tree correspondence processing ends.

On the other hand, when logic operators present in LF (Yes at Step S502), a logic operator operating on the outmost side in the predicate of LF is indicated as E2 (Step S506), the query on the left side and the query on the right side of E2 are indicated as LF2 and RF2, respectively (Step S507), and the logic symbol node Enode2 corresponding to E2 is specified (Step S508).

Left tree correspondence processing is performed using Lefttree (LF2, Enode2) as an input (Step S509), right tree correspondence processing is performed using Righttree(RF2, Enode2) as an input (Step S510), and the left tree correspondence processing ends. Note that the left tree correspondence processing shown at step S509 is similar to the left tree correspondence processing depicted in FIG. 24.

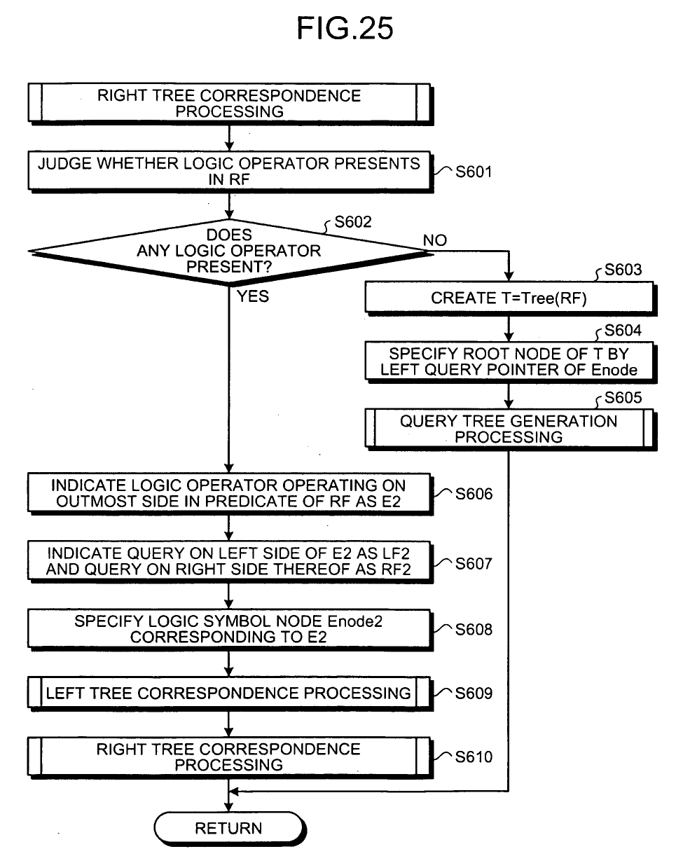

Next the right tree correspondence processing shown at step S410 in FIG. 23 will be explained. FIG. 25 is a flow chart representing the right tree correspondence processing. In FIG. 25, inputs are RF (query) and Enode (logic symbol node).

As depicted in FIG. 25, whether a logic operator presents in RF is judged (Step S601). When any logic operator does not present (No at Step S602), T=Tree(RF) is created (Step S603), the left query pointer of Enode specifies the root node of T (Step S604), query tree generation processing is performed (Step S605), and the right tree correspondence processing ends.

On the other hand, when logic operators present in RF (Yes at Step S602), a logic operator operating on the outmost side in the predicate of RF is indicated as E2 (Step S606), the query on the left side and the query on the right side of E2 are indicated as LF2 and RF2, respectively (Step S607), and the logic symbol node Enode2 corresponding to E2 is specified (Step S608).

Left tree correspondence processing is performed using Lefttree(LF2, Enode2) as an input (step S609), right tree correspondence processing is performed using Righttree (RF2, Enode2) as an input (step S610), and the left tree correspondence processing ends. Note that the left tree correspondence processing shown at step S609 is similar to that depicted in FIG. 24, and the right tree correspondence processing shown at step S610 is similar to that depicted in FIG. 25.

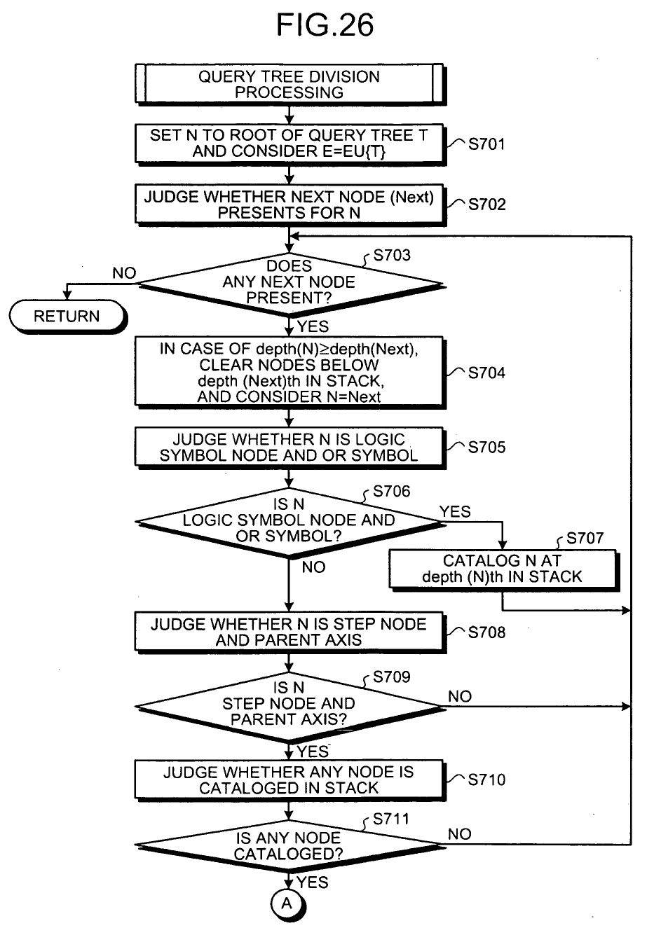

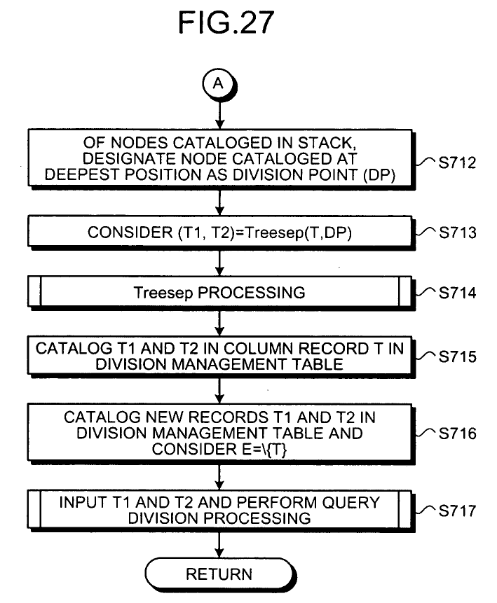

Next, the query tree division processing shown at step S105 in FIG. 20 will be explained. FIGS. 26 and 27 are flow charts representing processing procedures for the query tree division processing. In FIGS. 26 and 27, inputs are a query tree T, a set of query trees E, a division management table Tab, nodes N (each node of T in a depth-first walk or sequence).

As depicted in FIG. 26, N is set to the root of the query tree T, E=EU{T} is considered (Step S701), and whether a next node (Next) presents for N is judged (Step S702). When any next node does not present (No at Step S703), the query tree division processing ends.

On the other hand, when a next node (Next) presents for N (Yes at Step S703) and in case of depth(N)≧depth(Next), stack items below the depth (Next)th in the stack 150e are cleared, and N=Next is set (Step S704).

Next, whether N is a logic symbol node and an OR symbol is judged (Step S705). When N is a logic symbol node and an OR symbol (Yes at Step S706), N is registered at the depth (N)th in the stack 150e (Step S707) and the procedure proceeds to Step S703.

On the other hand, when N is a logic symbol node but not an OR symbol (No at Step S706), whether N is a step node and a parent axis is judged (Step S708). When N is a step node but not a parent axis (No at Step S709), the procedure proceeds to Step S703.

On the other hand, when N is a step node and a parent axis (Yes at Step S709), whether any node is registered in the stack 150e is judged (Step S710). When no node is registered (No at Step S711), the procedure proceeds to Step S703.

On the other hand, when any node is registered in the stack 150e (Yes at Step S711), a node (logic symbol node) registered at the deepest position of the nodes registered in the stack is designated as a division point (DP) (Step S712).

Then, (T1, T2)=Treesep(T,DP) is considered (Step S713), Treesep processing is performed using (T1, T2)=Treesep(T,DP) as an input (Step S714). Subsequently, T1 and T2 are registered in the column of record T in the division management table 150d (Step S715), new records T1 and T2 are registered in the division management table 150d, E=\{T} is considered (Step S716). Query tree division processing is performed using T1 and T2 as inputs (Step S717), and the query tree division processing ends. Note that the query tree division processing shown at step S717 corresponds to that depicted in FIGS. 26 and 27.

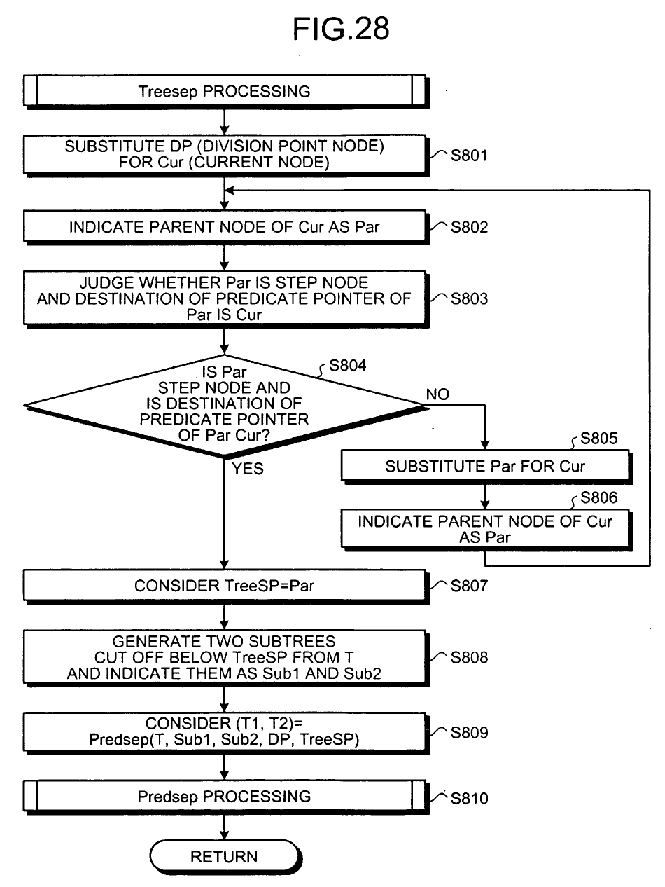

Next, the Treesep processing shown at step S714 in FIG. 27 will be explained. FIG. 28 is a flow chart representing processing procedures of the Treesep processing. In FIG. 28, inputs are T (query tree) and DP (division point node<node at division point), and outputs are query trees T1 and T2 after division of the query tree T. Each local variable in FIG. 28 will be explained. Sub1 and Sub2 represent subtrees of T at first, and then subtrees of T1 and T2, respectively, Cur represents a current node, Par represents a parent node of Cur, and TreeSP represents a step node that is an ancestor of DP (the top of Sub1 and Sub2).

As depicted in FIG. 28, DP (division point node) is substituted for Cur (current node) (Step S801), the parent node of Cur is indicated as Par (Step S802), and whether Par is a step node and whether a predicate pointer of Par points to Cur are judged (Step S803).

When Par is a step node and any predicate pointer of Par does not point to Cur, (No at Step S804), Par is substituted for Cur (Step S805), the parent node of Cur is indicated as Par (Step S806), and the procedure proceeds to Step S802.

On the other hand, when Par is a step node and the predicate pointer of Par points to Cur (Yes at Step S804), TreeSP=Par is considered (Step S807), two subtrees cut off below TreeSP are generated from T, and the two subtrees are indicated as Sub1 and Sub2 (Step S808).

Then, (T1, T2)=Predsep(T, Sub1, Sub2, DP, TreeSP) is considered (Step S809), and Predsep processing is performed using (T1, T2)=Predsep(T, Sub1, Sub2, DP, TreeSP) as an input (Step S810).

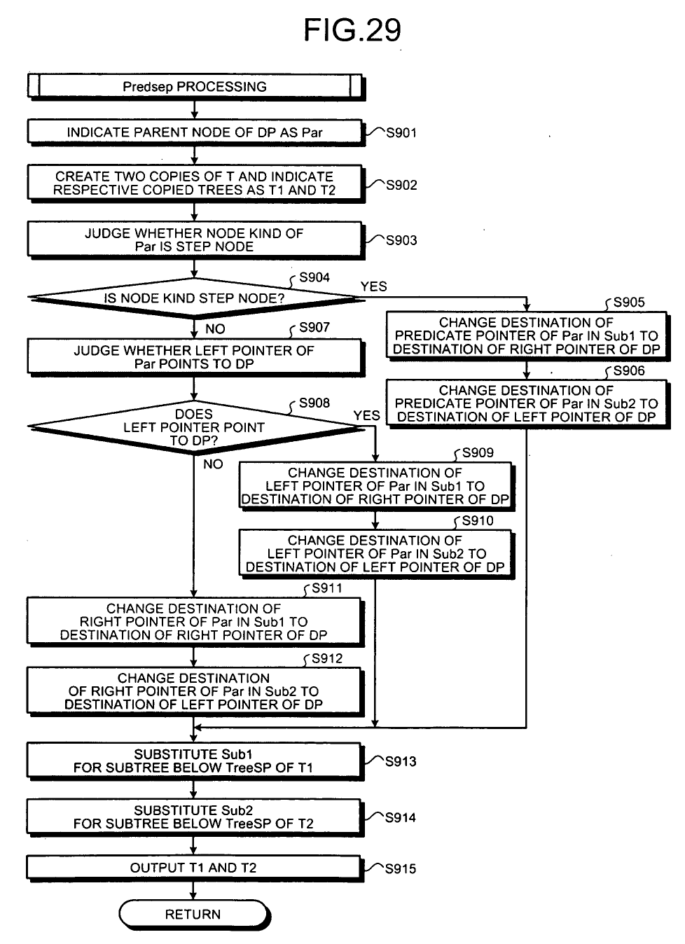

Next, the Predsep processing shown at Step S810 in FIG. 28 will be explained. FIG. 29 is a flow chart representing processing procedures of the Predsep processing. In FIG. 29, inputs are T (query tree), Sub1 and Sub2 (subtrees of T), DP (division point node of T), and TreeSP (top of Sub1 and Sub2), and outputs are query trees T1 and T2 after dividing T. Note that Par represents a parent node of DP.

As depicted in FIG. 29, a parent node of DP is indicated as Par (Step S901), two copies of T are created and each of the copies is indicated as T1 or T2 (Step S902), and whether a node kind of Par is step node is judged (Step S903).

When the node kind of Par is step node (Step S904, YES), a destination of a predicate pointer of Par in Sub1 is changed to the destination of the right pointer of DP (Step S905), a destination of a predicate pointer of Par in Sub2 is changed to the destination of the left pointer of DP (Step S906), and the procedure proceeds to step S913.

On the other hand, when the node kind of Par is logic symbol node (No at Step S904), whether the left pointer of Par points to DP is judges (Step S907). When the left pointer points to DP (Yes at Step S908), the destination of the left pointer of Par in Sub1 is changed to the destination of the right pointer of DP (Step S909), the destination of the left pointer in Sub2 is changed to the destination of the left pointer of DP (Step S910), and the procedure proceeds to Step S913.

On the other hand, when the right pointer of Par points to DP (No at Step S908), the destination of the right pointer of Par in Sub1 is changed to the destination of the right pointer of DP (Step S911), the destination of the right pointer of Par in Sub2 is changed to the destination of the left pointer of DP (Step S912).

Then, Sub1 is substituted for the subtree below the TreeSP of T1 (Step S913), Sub2 is substituted for the subtree below TreeSP of T2 (Step S914), T1 and T2 are output (Step S915), and the Predsep processing ends.

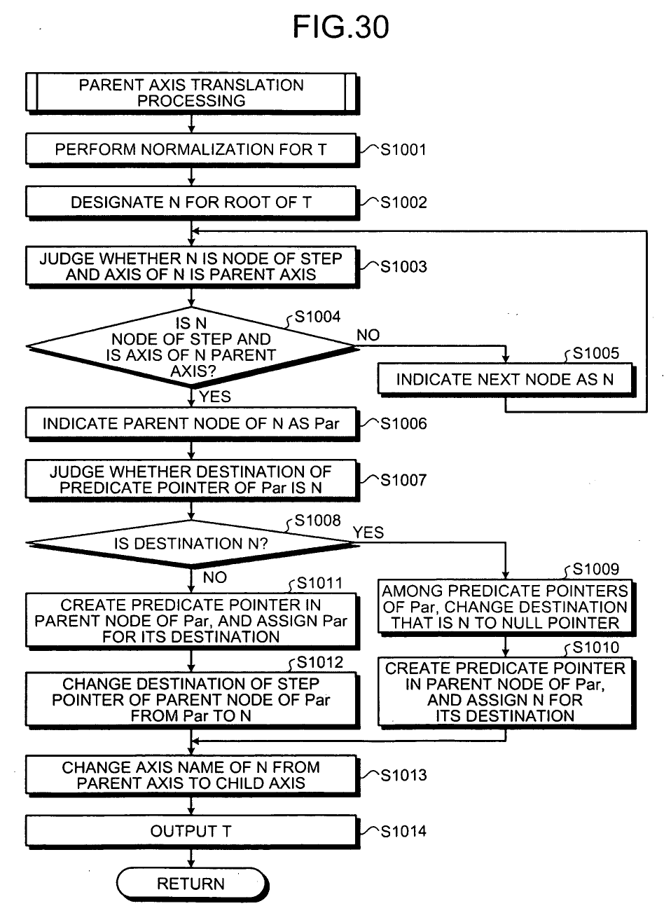

Next, the parent axis translation processing shown at step S107 in FIG. 20 will be explained. FIG. 30 is a flow chart representing processing procedures of the parent axis translation processing. In FIG. 30, an input is a query tree T. Further, each local variable in FIG. 30 will be explained. N represents a node of T and Par represents a parent node of N.

As depicted in FIG. 30, normalization is carried out for T (Step S1001), N is designated for the root of T (Step S1002), and whether N is a step node and whether the axis of N is a parent axis are judged (Step S1003).

When N is a step node and the axis of N is not a parent axis (No at Step S1004), the next node is indicated as N (Step S1005), and the procedure proceeds to Step S1003. On the other hand, when N is a step node and the axis of N is a parent axis (Yes at Step S1004), the parent node of N is indicated as Par (Step S1006), and whether a destination of a predicate pointer of Par is N is judged (Step S1007).

When a destination of a predicate pointer of Par is N (Yes at Step S1008), the predicate pointer whose destination is N among the predicate pointers of Par is changed to a null pointer (Step S1009), a predicate pointer is created in the parent node of Par, N is assigned for the destination of the new pointer (Step S1010), and the procedure proceeds to Step S1013.

On the other hand, when a destination of a predicate pointer of Par is not N (No at Step S1008), a predicate pointer is created in the parent node of Par and Par is assigned for the destination of the created pointer (Step S1011), and the destination of the step pointer of the parent axis of Par is changed from Par to N (Step S1012).

The axis name of N is changed from parent axis to child axis (Step S1013), T is output (Step S1014), and the parent axis translation processing ends.

As described above, the search device 100 according to the first embodiment does not divide a query into subqueries using all OR operators in the query as division points unlike in the conventional technology, specifies OR operators necessary for division (OR operators in portions of OR condition containing reverse axes and OR operators), and divides the query into subqueries using only the specified OR operators as division points; therefore, the number of subqueries generated in equivalent translation of the query containing OR operators can be reduced, which leads to possible reduction in computational cost of data search for query.

Specifically, by use of the technique of the first embodiment, for example, when the query “Q5=/Syain/ACT[(id or ../title)and(chara or cast)]” is divided into subqueries, they are
q1=/Syain/ACT[id and (chara or cast)] and
q2=/Syain/ACT[../title and (chara or cast)].

On the other hand, when the query “Q5=/Syain/ACT[(id or ../title)and(chara or cast)]” is divided into subqueries based on the conventional technology, they are
q1=/Syain/ACT[id and chara],
q2=/Syain/ACT[id and cast],
q3=/Syain/ACT[../title and chara], and
q4=/Syain/ACT[../title and cast].

Accordingly, the number of the subqueries divided by the conventional technology and the number of the subqueries divided by the technique of the first embodiment are compared with each other, the number of the subqueries divided by the technique of the first embodiment is smaller, and therefore the search device is capable of reducing the number of search for query and the computational cost.

The embodiment of the present invention has been described above; however, the present invention may be implemented in various different forms other than the first embodiment. Hereinafter, another embodiment included in the present invention will be explained as a second embodiment.

For example, in the first embodiment, child axis is considered as forward axis and parent axis is considered as reverse axis; however they are not limited to the above. Forward axes include, other than child axis, descendant axis, descendant or self axis, following-sibling axis, and preceding axis. Reverse axes include, other than parent axis, ancestor axis, ancestor or self axis, preceding-sibling axis, and following-axis.

The search device 100 according to the first embodiment can reduce the number of division of subqueries similarly with the use of the technique of the first embodiment even though the forward axes are other than child axes (for example, descendant axis, descendant or self axis, following-sibling axis, and preceding axis) and reverse axes are other than parent axes (for example, ancestor axis, ancestor or self axis, preceding-sibling axis, and following axis).

Among the processing explained in the first embodiment, all or part of the processing explained as processing automatically performed can be manually carried out, or all or part of the processing explained as processing manually carried out can be performed automatically in a well known manner. Other than this, the processing procedures, control procedures, specific names, and information including various data and parameters depicted in the document and drawings can be arbitrarily changed unless otherwise specified.

Each component of the search device 100 depicted in FIG. 8 is functionally conceptual, and the search device 100 is not necessarily configured physically as depicted in FIG. 8. In other words, specific formation of the distribution and integration of each device is not limited to that depicted in FIG. 8, and all or part of the formation can be functionally or physically distributed and integrated per arbitrary unit depending on various loads and use conditions. Further, all or arbitrary part of each processing function performed by each device is realized by programs analyzed and implemented by a central processing unit (CPU) or an applicable CPU, or can be realized by wired logic as hardware.

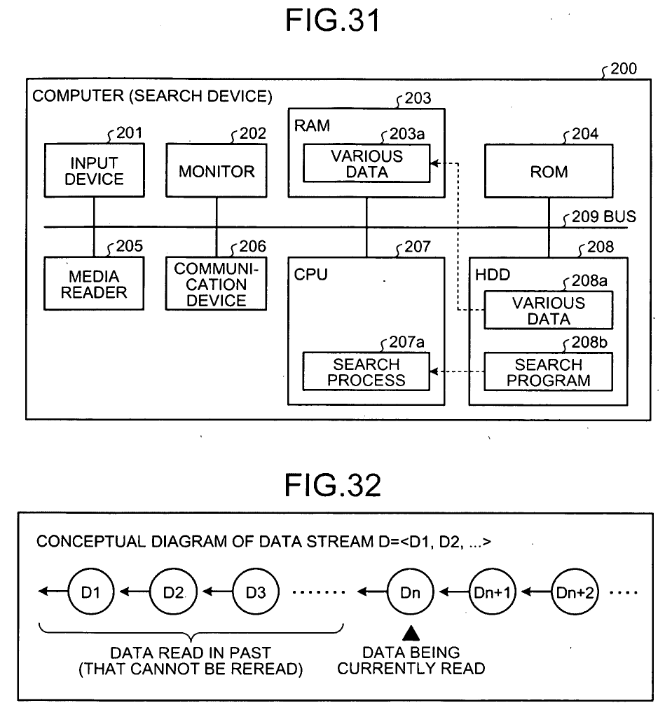

FIG. 31 is a diagram representing a hardware configuration of a computer 200 configuring the search device 100 according to the first embodiment. As depicted in FIG. 31, the computer (search device) 200 is configured by connecting by a bus 209 an input device 201, a monitor 202, random access memory (RAM) 203, read only memory (ROM) 204, a media reader 205 that reads data from memory media, a communication device 206 that transmits to and receives data from other devices (for example, the terminal device 50), a central processing unit (CPU) 207, and hard disk drive (HDD) 208.

The HDD 208 stores a search program 208b that exerts functions similar to those of the search device 100. Search process 207a is initiated when the CPU 207 reads out and implements the search program 208b. Here, the search process 207a corresponds to the query receiving unit 160a, the reverse axis detecting unit 160b, the division point judging unit 160c, the axis translation executing unit 160d, the query evaluating unit 160e, and the search result transmitting unit 160f that are depicted in FIG. 8.

Further, the HDD 208 stores various data 208a corresponding to the XML data 150a, the query data 150b, the query tree data 150c, the division management table 150d, the stack 150e, and the translated query data 150f. The CPU 207 reads out the various data 208a stored in the HDD 208, stores them in the RAM 203, divides a query with the use of various data 203a stored in the RAM 203, and then evaluates each subquery, followed by performing data search.

The search program 208b depicted in FIG. 31 is not necessarily stored in the HDD 208 from the beginning. The search program 208b may be stored, for example, in “a mobile physical medium” such as a flexible disk (FD), a compact disc read-only memory (CD-ROM), a digital versatile disc (DVD), a magneto-optic disk, and an integrated circuit (IC) card that are inserted into a computer, or in “a fixed physical medium” such as a hard disk drive (HDD) provided inside and outside of a computer, as well as in “another computer (or a server)” connected to the computer via public switched telephone networks, the Internet, a local-area network (LAN), a wide area network (WAN), and the like, and the computer may read out the search program 208b from them and implement it.

According to embodiments of the query translation method, when reverse axes are contained, portions of OR condition containing OR operators are specified, OR operators in the specified portions of OR condition that become division points are judged, and the query is divided into subqueries based on the division points, followed by translating the reverse axes into forward axes, and therefore the number of subqueries that become evaluation targets and the computational cost can be reduced.

Further, according to the embodiments of the query translation method, when OR operators and reverse axes are contained in portions of OR condition, the OR operators in the portions of OR condition are judged as division points, and therefore the query to be divided can be effectively divided.

Furthermore, according to the embodiments of the query translation method, when parent axes are contained at levels below OR conditions in the tree structure of a search query, it is judged that reverse axes are contained, and therefore division points can be accurately judged.

Still further, according to embodiments the search device, when reverse axes are contained, portions of OR condition containing OR operators are specified, OR operators in the specified portions of OR condition that become division points are judged, and the query is divided into subqueries based on the division points, followed by translating the reverse axes into forward axes, and therefore the number of subqueries that become evaluation targets and the computational cost can be reduced.

Still further, according to the embodiments of the search device, when OR operators and reverse axes are contained in portions of OR condition, the OR operators in the portions of OR condition are judged as division points, and therefore the query to be divided can be effectively divided.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

What is claimed is:

1. A query translation method for a search device that evaluates a search query containing logical expressions and searches for applicable data from document data having a hierarchical structure, the query translation method comprising:
judging whether a reverse axis is contained in the search query;
specifying a portion of OR condition containing an OR operator in the search query when the search query contains the reverse axis;
judging the OR operator in the specified portion of OR condition that defines a division point for dividing the search query into subqueries;
dividing the search query into the subqueries based on the OR operator defining the division point; and
translating the reverse axis contained in the subqueries into a forward axis.

2. The query translation method according to claim 1, wherein the judging the OR operator includes judging, when the OR operator and the reverse axis are contained in the portion of OR condition, the OR operator contained in the portion of OR condition as the division point.

3. The query translation method according to claim 1, wherein when a tree structure of the search query contains a parent axis at levels below the OR condition, the judging the reverse axis judges that the reverse axis is contained.

4. A search device that evaluates a search query containing logical expressions and searches for applicable data from document data having a hierarchical structure, the search device comprising:
a reverse axis judging unit that judges whether a reverse axis is contained in the search query;
a division judging unit that specifies a portion of OR condition containing an OR operator in the search query when the search query contains the reverse axis, and judges the OR operator in the specified portion of OR condition that defines a division point for dividing the search query into subqueries; and
a translating unit that divides the search query into the subqueries based on the OR operator defining the division point, and translates the reverse axis contained in the subqueries into a forward axis.

5. The search device according to claim 4, wherein when the OR operator and the reverse axis are contained in the portion of OR condition, the division judging unit judges the OR operator contained in the portion of OR condition as the division point.

6. The search device according to claim 4, wherein when a tree structure of the search query contains a parent axis at levels below the OR condition, the reverse axis judging unit judges that the reverse axis is contained.

7. A computer-readable recording medium that stores therein a computer program for a search device that evaluates a search query containing logical expressions and searches for applicable data from document data having a hierarchical structure, the computer program causing a computer to execute:
judging whether a reverse axis is contained in the search query;
specifying a portion of OR condition containing an OR operator in the search query when the search query contains the reverse axis;
judging the OR operator in the specified portion of OR condition that defines a division point for dividing the search query into subqueries;
dividing the search query into the subqueries based on the OR operator defining the division point; and
translating the reverse axis contained in the subqueries into a forward axis.
